(19) United States
(12) Patent Application Publication
(10) Pub. No.: US 2008/0235760 A1
(43) Pub. Date: Sep. 25, 2008

(54) Confidential Content Reporting System and Method with Electronic Mail Verification Functionality

(75) Inventors: Scott J. Broussard, Cedar Park, TX (US); Tony C. Kwong, Cary, NC (US); Eduardo N. Spring, Round Rock, TX (US); Anthony W. Wrobel, Raleigh, NC (US)

Correspondence Address: IBM CORP. (WIP);c/o WALDER INTELLECTUAL PROPERTY LAW, P.C., P.O. BOX 832745, RICHARDSON, TX, 75083, US

(73) Assignee: International Business Machines Corporation, Armonk, NY (US)

(21) Appl. No.: 12/129,072

(22) Filed: May 29, 2008

Related U.S. Application Data
(63) Continuation of application No. 11/381,151, filed on May 2, 2006.

(51) Int. Cl. H04L 9/00; G06N 5/02

(52) U.S. Cl. 726/1

(57) ABSTRACT

A confidential content reporting system and method with electronic mail verification functionality are provided. With the system and method, a security compliance search engine is provided for searching items of information to identify items containing confidential content and security violations with regard to this confidential content. Results of the search may be reported to a user via a graphical user interface (GUI) that identifies the item of information, the security violations detected, and suggested corrective actions, such as encryption. A user may interact with the GUI to apply security mechanisms in accordance with the suggested corrective actions. Moreover, the searching and reporting mechanism may be used to search electronic mail messages and their attachments prior to distribution of the electronic mail messages. Automatic modification of the electronic mail message to modify distribution lists and/or content of the electronic mail message may be performed using the mechanisms of the illustrative embodiments.

### BACKGROUND OF THE INVENTION

1. Technical Field

The illustrative embodiments herein relate generally to an improved data processing system and method. More specifically, the illustrative embodiments are directed to a system and method for searching a computing device for confidential content and reporting security policy violations in such a manner that appropriate security actions may be taken. Moreover, the illustrative embodiments provide a mechanism for verifying that electronic mail messages and their attachments are in compliance with security policies and if not, reporting and/or automatically correcting violations of security policies in electronic mail messages and/or their attachments.

2. Description of Related Art

Maintaining the security of confidential files, e.g., image files, document files, data files, and the like, is a major concern for both government and business organizations. If an organization is not able to control the dissemination of their confidential files, many potentially harmful disclosures of information may occur. The consequences of such harmful disclosures may cause an organization to lose market share, lose trade secrets, or, in the case of government organizations, may actually lead to placing individuals in harm's way.

Typically, an organization has a written policy for ensuring the security of such files, however the implementation of this written policy is left up to the individual employees of the organization. For example, an organization may require that all electronic mail attachments be encrypted, however it is left up to the employee to actually abide by the policy. Whenever a security policy is left up to a human being for implementation, a potential source of error exists where the security policy may not be followed, or at least may not be followed in every situation.

Recently, desktop search engines have been developed for searching a user's own computer. These desktop search engines are client resident programs that search and index electronic mail, files, web browser history, and instant messages on a client computer's storage device. Examples of such desktop search engines include Google Desktop™, X1 Desktop™, and Microsoft Windows Vista™.

With these desktop search engines, a user may enter search terms into a field of the search engine and the search engine will search the electronic mail, files, web browser history, and instant messages to identify those entities that contain that search term. The search term may be found in the content of the entity, meta-tags of the entity, or the like. Results of the search may then be provided to the user. In this way, the user is able to obtain easy access to information on their personal computer by performing a text, search term based, search.

### SUMMARY OF THE INVENTION

In view of the above, it would be beneficial to have a system and method that implements the searching of client computing devices so as to ensure compliance of items of information on the client computing device with security policies of an organization with which the client computing device or user is associated. The illustrative embodiments of the present invention provide such a system and method for ensuring compliance with security policies.

With the illustrative embodiments, a security compliance search engine is provided for searching one or more client computing devices for items of information that meet a security criteria established by an individual or organization. For example, the security compliance search engine searches for items of information that have confidential information. The term “item of information,” as it is used in the present description, refers to any individually identifiable collection of data. Examples of items of information include electronic mails, electronic files, objects in an object oriented environment, electronic documents, electronic images, and the like. In the present description, the term “confidential information” means information to which security policies are to be applied in order to ensure that the information is not accessible by unauthorized individuals.

The security compliance search engine uses a set of security search rules for determining how to locate and rate items of information that contain confidential information. These security search rules may include, for example, searching for particular character strings in the content of the item of information or in meta-information associated with the item of information, e.g., “Confidential,” “SSN:,” “Personal,” “Private,” “Secret,” or the like.

The security search rules may further include rules for searching indicators of confidentiality, e.g., data flags, particular parameters of the item of information being set, file system settings associated with the item of information, etc., in the content of the item of information or in meta-information associated with the item of information. Embodiments may also comprise rules for searching file name patterns to identify items of information that contain confidential information or even file usage patterns, as may be obtained from a usage log for example, that are indicative of confidential information being present. The rules may comprise subsets of rules for various types of items of information, e.g., subsets of rules for various file types, formats, and the like. Moreover, the same character strings noted above, e.g., “Confidential,” “SSN:,” and the like, may also be indicators of confidentiality.

The security compliance search engine may be provided on a server computing device and may remotely administer searches of client computing devices. The security compliance search engine may make use of a client computing device database to retrieve information about the client computing devices that are to be searched using the mechanisms of the security compliance search engine.

In remotely administering searches of client computing devices, the security compliance search engine may download or transfer a client agent to the client computing devices which may run the client agent to collect information from the client computing device and provide the information back to the server. For example, the client agent may collect information about the items of information present on the client computing device and provide this information, in a secure manner, back to the server for analysis using the security search rules. Alternatively, the client agent may actually perform the search of the items of information on the client computing device using the security search rules present on the server.

For items of information meeting one or more criteria set forth in the security search rules, characteristic information may be gathered about these items of information. This characteristic information may comprise, for example, identification of the item of information, the criteria met by the item of information, characteristic information about the item of information, information identifying the protection mechanisms currently applied to the item of information on the client computing device, and the like. This characteristic information may be used by the security compliance search engine to determine if the item of information is being maintained in accordance with established security policies.

The security compliance search engine may use the characteristic information gathered about the item of information to identify one or more security policies in a security policy database that apply to that item of information. The one or more security policies may then be applied to the characteristic information gathered about the item of information to determine if the item of information is being maintained in compliance with applicable security policies. Results of the application of the one or more security policies may be logged and maintained in the client computing device database, for example. In addition, the results may be used to generate reports and notifications that are sent to the client computing device and/or an administrator's computing device. In this way, the user of the client computing device and/or the administrator may be notified of any violations of the security policy. Moreover, solutions for placing the item of information in compliance with the security policy may be provided as part of the log, report and/or notification.

In a further embodiment, the security compliance search engine may be distributed from a server to client computing devices such that the security compliance search engine is run on the client computing device and results are provided back to a server for logging and reporting. In such an embodiment, the security search rules may be provided to the client computing devices such that these rules are applied by the client-based security compliance search engine in searching the client computing device upon which the client-based security compliance search engine runs. Because these security search rules may be updated from time to time, the client-based security compliance search engine may periodically communicate with the server to download the most recent updates to the security search rules.

Results of the security search of the client computing device may be returned to the server which may then apply the security policies to these search results as discussed previously. Alternatively, in a similar manner as the security search rules, the security policies may be downloaded to the client computing devices such that the application of the security policies to the results of the security search may be performed on the client computing device. Results of the application of the security policies to the results of the security search may be logged and maintained in the server and/or the client computing device and may be reported to the user of the client computing device and/or an administrator in a similar manner as previously discussed.

To report the results of such searching the illustrative embodiments provide a graphical user interface generation engine that generates a graphical user interface that may be provided to a system administrator, end client user, or other interested party. The graphical user interface provides a listing of documents detected as having confidential content and which do not meet security policy requirements. The graphical user interface may further provide, for each such document found to be in violation of security policy requirements, a description of the violation that was detected as well as a description of one or more associated solutions that may be applied to the document to bring it into compliance with the security policy requirements.

Via the graphical user interface, a user may select a document from the listing and one of the one or more listed solutions to thereby have the associated solution automatically applied to the selected document. In automatically applying the selected solution to the selected document, the graphical user interface may generate one or more sub-menus, or other graphical user interface elements, for selecting attributes for the selected solution. Such attributes may include, for example, a particular organizational level for which the document is to be accessible. An pre-established security setting, such as an encryption key or the like, that is associated with the selected security attribute may then be retrieved and utilized with the selected security solution to apply the security solution to the selected document.

In yet a further illustrative embodiment, a mechanism is provided for automatically scanning electronic mail messages and their associated attachments to determine if they are in compliance with established security policies. If either the electronic mail message itself or the attachment(s) to the electronic mail message are not in compliance with established security policies, a report may be generated and provided to a user such as via a graphical user interface as previously described.

In one illustrative embodiment, solutions for bringing the electronic mail message into compliance with the security policies may be automatically applied to the electronic mail message and/or its attachments. For example, if the electronic mail message and/or its attachments contain confidential content and are not in compliance with established security policies, the distribution list for the electronic mail message may be automatically modified such that the confidential content is not distributed to individuals that may pose a security risk. Moreover, encryption mechanisms and/or other security solutions may be automatically identified for application to the electronic mail message and/or its attachments and automatically applied. For example, from the electronic mail message's distribution list, it may be determined what level of access within an organization is to be associated with the electronic mail message and its associated attachments and thus, a corresponding security attribute may be selected and used with an automatically selected security mechanism for application to the electronic mail message and its attachments.

In one illustrative embodiment, a method is provided for reporting items of information containing confidential information. The method may comprise identifying at least one item of information containing confidential information based on one or more security search rules setting forth one or more security criteria for identifying items of information that contain confidential information. The at least one item of information may be analyzed to determine if the at least one item of information meets security policy compliance requirements. The security policy compliance requirements may identify requirements for maintaining items of information that contain confidential information in a confidential state.

The method may further comprise identifying one or more security policy violations based on results of the analysis if the results indicate that the at least one item of information does not meet security policy compliance requirements. An output may be provided that identifies the at least one item of information and includes, for each item of information in the at least one item of information, an identifier of the item of information and one or more security policy violations associated with the item of information. The output may further include an identifier of one or more suggested corrective actions for correcting the one or more security policy violations.

Providing the output may comprise providing a graphical user interface. The graphical user interface may include one or more graphical user interface elements associated with the one or more suggested corrective actions. The one or more graphical user interface elements may be selectable by a user to perform the one or more associated corrective actions.

The method may further comprise receiving first user input that selects an item of information from the at least one item of information and receiving second user input that selects one of the one or more suggested corrective actions associated with the selected item of information. One or more operations associated with the selected suggested corrective action may be automatically applied to the selected item of information in response to the first and second user inputs.

A secondary graphical user interface element may be provided, in response to the second user input, that identifies one or more security attributes to be utilized by operations associated with the selected suggested corrective action. Third user input may be received that selects one of the one or more security attributes. The one or more security attributes may include a particular organizational level for which the selected item of information is to be accessible.

The method may further comprise retrieving a pre-established security setting associated with the selected security attribute. The pre-established security setting may be provided to the one or more operations associated with the selected suggestive corrective action. The pre-established security setting is an encryption key.

The method may further comprise automatically identifying one or more corrective actions to correct the one or more security policy violations. The identified one or more corrective actions may be automatically applied to the at least one item of information to bring the at least one item of information into compliance with security policies.

The at least one item of information may be an electronic mail message. The one or more corrective actions may include at least one of automatically modifying a distribution list for the electronic mail message to not include unauthorized individuals that may pose a security risk, automatically encrypting the electronic mail message, or automatically encrypting an attachment to the electronic mail message.

In further illustrative embodiments, a computer program product comprising a computer useable medium having a computer readable program is provided. The computer readable program may, when executed on a computing device, causes the computing device to perform various ones of the operations described above with regard to the method illustrative embodiment.

In yet further illustrative embodiments, a system is provided that may comprise a processor and a memory. The memory may contain instructions which, when executed by the processor, cause the processor to perform various ones of the operations described above with regard to the method illustrative embodiment.

These and other features and advantages will be described in, or will become apparent to those of ordinary skill in the art in view of, the following detailed description of the exemplary embodiments of the present invention.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram of a distributed data processing system in which aspects of the illustrative embodiments may be implemented;

FIG. 2 is an exemplary block diagram of a server computing device in which aspects of the illustrative embodiments may be implemented;

FIG. 3 is an exemplary block diagram of a client computing device in which aspects of the illustrative embodiments may be implemented;

FIG. 4 is an exemplary diagram illustrating operational elements of an illustrative embodiment;

FIG. 5 is an exemplary diagram illustrating exemplary components of a security compliance search engine in accordance with an illustrative embodiment;

FIG. 6 is a flowchart outlining an exemplary operation for determining compliance of items of information on a client computing device in accordance with an illustrative embodiment;

FIG. 7 is an exemplary block diagram illustrating a graphical user interface generation engine in accordance with an illustrative embodiment;

FIG. 8 is an exemplary diagram of a GUI that may be output in accordance with one illustrative embodiment;

FIG. 9 is a flowchart outlining an exemplary operation for providing a graphical user interface in accordance with one illustrative embodiment;

FIG. 10 is an exemplary diagram illustrating an operation of an electronic mail message security compliance verification mechanism in accordance with an illustrative embodiment;

FIG. 11A is an exemplary diagram illustrating an initial electronic mail message as composed by a user;

FIG. 11B is an exemplary diagram illustrating a modified electronic mail message that is generated based on the electronic mail message shown in FIG. 11A and the application of security mechanisms in accordance with an illustrative embodiment; and

FIG. 12 is a flowchart outlining an exemplary operation for ensuring compliance of electronic mail messages and their attachments with security policies in accordance with one illustrative embodiment.

### DETAILED DESCRIPTION OF THE PREFERRED EMBODIMENTS

The illustrative embodiments of the present invention provide mechanisms for ensuring compliance of client computing devices in the maintaining and distribution of items of information that contain confidential content. As such, the mechanisms of the illustrative embodiments are especially well suited for implementation in a distributed data processing system having a plurality of computing devices that communicate with one another by way of one or more networks. The following FIGS. 1-3 are provided as examples of a distributed data processing system, server computing device, and client computing device in which exemplary aspects of the illustrative embodiments may be implemented. It should be noted that the example computing environments illustrated in FIGS. 1-3 are not intended to state or imply any limitation as to the particular types of computing environments in which the exemplary aspects of the illustrative embodiments may be implemented. Rather, many modifications to the depicted computing environments may be made without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

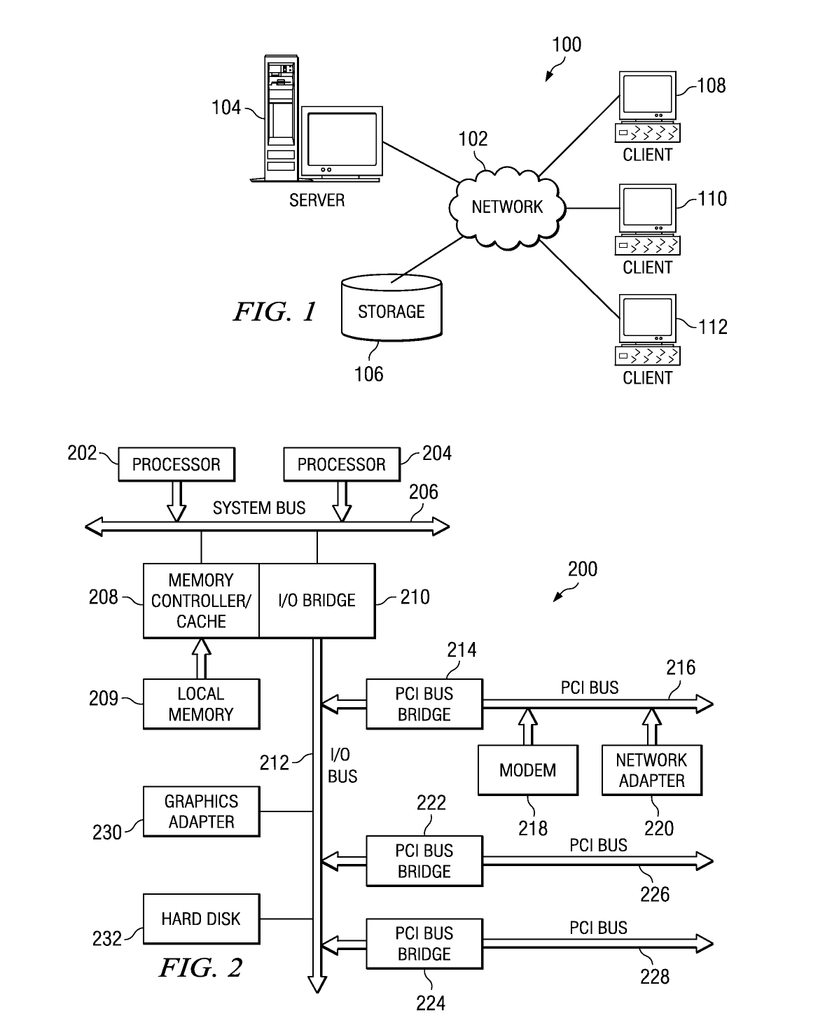

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

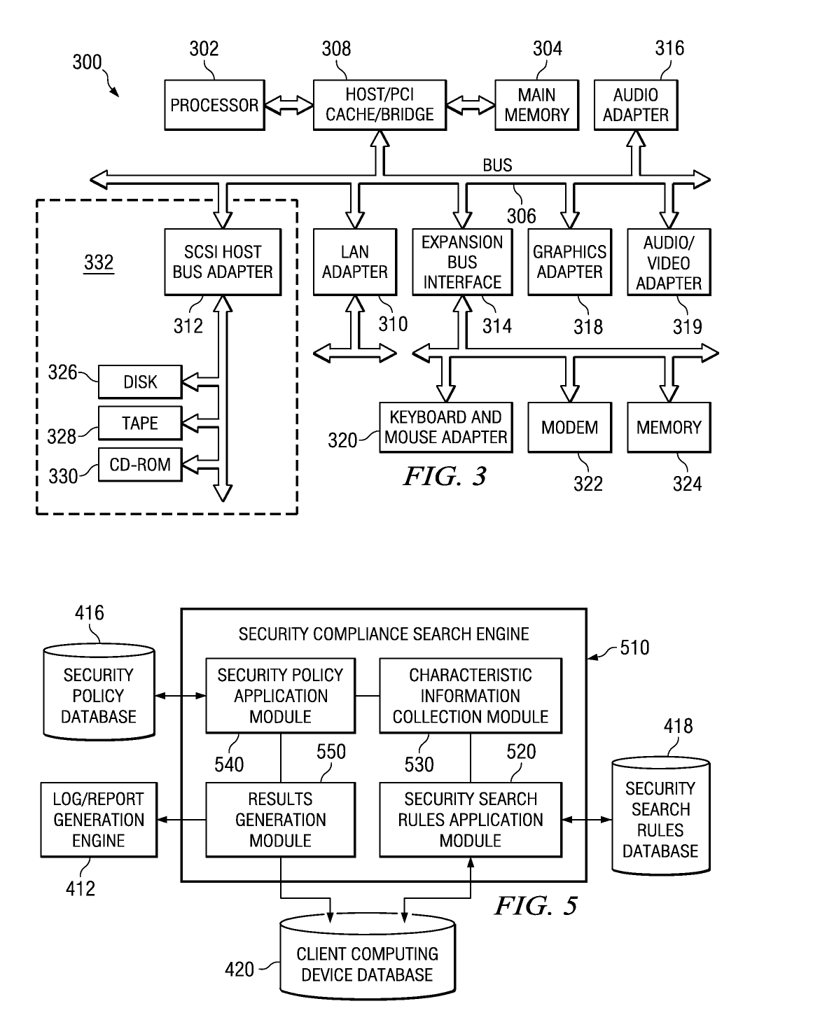

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI Bridge 308. PCI Bridge 308 also may include an integrated memory controller and cache memory for processor 302. Additional connections to PCI local bus 306 may be made through direct component interconnection or through add-in boards.

In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

With reference again to FIG. 1, the illustrative embodiments provide a security compliance search engine that may be resident on server 104 and/or may be downloaded to client devices 108-112 from a server such as server 104. The security compliance search engine is provided for searching one or more client computing devices 108-112 for items of information that meet a security criteria established by an individual or organization. For example, the security compliance search engine searches for items of information that have confidential information.

The security compliance search engine uses a set of security search rules for determining how to locate and rate items of information that contain confidential information. The security search rules may be maintained on the server 104 or in a separate storage system, such as storage system 106 in FIG. 1. The security search rules may include, for example, rules for searching for particular character strings in the content of the item of information or in meta-information associated with the item of information, e.g., “Confidential,” “SSN:,” “Personal,” “Private,” “Secret,” or the like. The security search rules may further include rules for searching indicators of confidentiality, e.g., data flags, particular parameters of the item of information being set, file system settings associated with the item of information, etc., in the content of the item of information or in meta-information associated with the item of information. Embodiments may also comprise rules for searching file name patterns to identify items of information that contain confidential information. The rules may comprise subsets of rules for various types of items of information, e.g., subsets of rules for various file types, formats, and the like.

The security compliance search engine, on server 104 for example, may remotely administer searches of client computing devices 108-112. The security compliance search engine may make use of a client computing device database, which may be stored on the server or another storage system such as storage system 106, to retrieve information about the client computing devices 108-112 that are to be searched using the mechanisms of the security compliance search engine.

In remotely administering searches of client computing devices 108-112, the security compliance search engine may download or transfer a client agent to the client computing devices 108-112 which runs the client agent to collect information from the client computing device 108-112 and provide the information back to the server 104. For example, the client agent may collect information about the items of information present on the client computing device and provide this information, in a secure manner, back to the server for analysis using the security search rules. Alternatively, the client agent may actually perform the search of the items of information on the client computing device 108-112 using the security search rules present on the server 104.

For items of information meeting one or more criteria set forth in the security search rules, characteristic information may be gathered about these items of information. This characteristic information may comprise, for example, identification of the item of information, the criteria met by the item of information, characteristic information about the item of information, information identifying the protection mechanisms currently applied to the item of information on the client computing device, and the like. This characteristic information may be used by the security compliance search engine to determine if the item of information is being maintained in accordance with established security policies.

The security compliance search engine may use the characteristic information gathered about the item of information to identify one or more security policies in a security policy database, which may also be stored on the server 104 or a separate storage system such as storage system 106, that apply to that item of information. The one or more security policies may then be applied to the characteristic information gathered about the item of information to determine if the item of information is being maintained in compliance with applicable security policies. Results of the application of the one or more security policies may be logged and maintained in the client computing device database, for example. In addition, the results may be used to generate reports and notifications that are sent to the client computing device 108-112 and/or an administrator's computing device. In this way, the user of the client computing device 108-112 and/or the administrator may be notified of any violations of the security policy by items of information maintained on the client computing device 108-112. Moreover, solutions for placing the item of information in compliance with the security policy may be provided as part of the log, report and/or notification.

In a further embodiment, the security compliance search engine may be distributed from the server 104 to the client computing devices 108-112 such that the security compliance search engine is run on the client computing device 108-112 and results are provided back to the server 104 for logging and reporting. In such an embodiment, the security search rules may be provided to the client computing devices 108-112 such that these rules are applied by the client-based security compliance search engine in searching the client computing device 108-112 upon which the client-based security compliance search engine runs. Because these security search rules may be updated from time to time, the client-based security compliance search engine may periodically communicate with the server 104 to download the most recent updates to the security search rules to the client computing devices 108-112.

Results of the security search of the client computing device 108-112 may be returned to the server 104 which may then apply the security policies to these search results as discussed previously. Alternatively, in a similar manner as the security search rules, the security policies may be downloaded to the client computing devices 108-112 such that the application of the security policies to the results of the security search may be performed on the client computing device 108-112. Results of the application of the security policies to the results of the security search may be logged and maintained in the server 104 and/or the client computing device 108-112 and may be reported to the user of the client computing device 108-112 and/or an administrator in a similar manner as previously discussed.

The security compliance search engine may be run on the client computing devices 108-112 in accordance with a schedule established by a user of the client computing device 108-112. The schedule is preferably established such that the security search is performed at a time when such a security search will not interfere with normal operation of the client computing device 108-112 by a user. Alternatively, the security compliance search engine may include a module for monitoring the current activity of the client computing device 108-112 and may initiate the security search at a time of detected inactivity of the client computing device 108-112. For example, if the client computing device 108-112 enters a sleep state, e.g., such as when a screensaver is initiated, or the user logs-out of the client computing device 108-112 but leaves the client computing device 108-112 running, the security compliance search engine may initiate a security search of the client computing device 108-112.

In addition, in order to ensure that the security compliance search engine is run periodically on the client computing devices 108-112, the server 104 may maintain information in the client computing device database identifying a last time that the security compliance search engine was run on each client computing device 108-112. The server 104 may remotely initiate the running of the security compliance search engine on the client computing device 108-112 when the elapsed time from the last time the security compliance search engine was run on that client computing device 108-112 exceeds a predetermined threshold.

As mentioned above, the security compliance search engine makes use of security search rules that govern the manner by which the security compliance search engine identifies items of information that contain confidential information. These items of information may be, for example, electronic documents, electronic images, electronic files, compilations of data, objects in an object oriented environment, or other units of data. Security search rules may be established for various types of items of information, e.g., various file formats such as Microsoft Word™ documents, Adobe Acrobat™ documents, JPEG image files, bitmap image files, Freelance Graphics™ files, Microsoft PowerPoint™ files, Microsoft Excel™ files, and the like. Security search rules may be established for identifying particular filename patterns indicative of confidential information being contained in the files, e.g., a filename with the string “secret,” “confidential,” “_c,” “_s, ” or the like.

The security search rules may further designate text strings to be looked for in the actual content of the item of information. Thus, for example, a security search rule may look into the content of an electronic document to determine if the electronic document includes the word “confidential” as a title item in the electronic document, includes a text string “SSN:” indicative of a person's social security number, or the like. Other security search rules may be established for identifying, either in the content of the items of information, in the filenames of the items of information, meta-information describing the item of information, or the like, indicators of confidentiality of the item of information. The particular security search rules that are used will depend upon the particular implementation of the illustrative embodiments according to the particular interests and concerns of the individual or organization using the illustrative embodiments of the present invention.

The security search rules, as applied by the security compliance search engine, provide a mechanism for identifying those items of information on a client computing device that contain confidential information. Having identified those items of information, the security compliance search engine uses security policies to determine if the manner by which those items of information are being maintained meets with the security policies established by the individual or organization. In order to make such a determination, characteristic information regarding the items of information may be obtained from the client computing device and used with the security policies to determine if the item of information is being maintained in accordance with the security policies. This characteristic information may include, for example, a path to access the item of information, file system settings associated with the item of information (e.g., is the file a hidden file), archive settings for the item of information, whether the item of information is behind a firewall, whether the item of information is only accessible through a password mechanism, and the like. Security policies may be applied to such characteristic information to see if the security policies are met or not met by the particular manner in which the item of information is maintained on the client computing device.

For example, a security policy may be that all items of information that contain confidential information must be maintained in client computing devices in an encrypted format. If, during the security search, an item of information containing confidential information is identified, and the characteristic information obtained from the client computing device 108-112 indicates that the item of information is not encrypted, the client computing device 108-112 is determined to be maintaining the item of information in violation of the security policy. The security policy may further dictate, for example, that any items of information found to be in violation of the security policy must be viewed by the user of the client computing device no later than a specified number of days from a date of the security search or that the items of information must be viewed by the user by a certain time. In such a case, such items of information may be automatically deleted after viewing by the user, e.g., in the case of electronic mail items having confidential content.

As a result, the violation may be logged and a report sent to the user of the client computing device 108-112 and/or an administrator or other security monitor's computing device. This report may designate the security policy that has been violated, the item of information that has been determined to be in violation of the security policy, and may provide information as to how the user of the client computing device 108-112 may bring his client computing device 108-112 back into compliance with security policies with regard to the identified item of information. Other information may also be provided in the report in addition to, or in replacement of, the information noted above.

Thus, the illustrative embodiments of the present invention provide mechanisms for searching a client computing device for items of information that contain confidential information and obtaining characteristic information regarding the manner by which the item of information is being maintained in the client computing device. The illustrative embodiments further provide mechanisms for determining whether the manner by which the item of information is being maintained in the client computing device violates any established security policies. The illustrative embodiments also provide mechanisms for reporting security policy violations and providing information regarding how to bring client computing devices back into compliance with the established security policies.

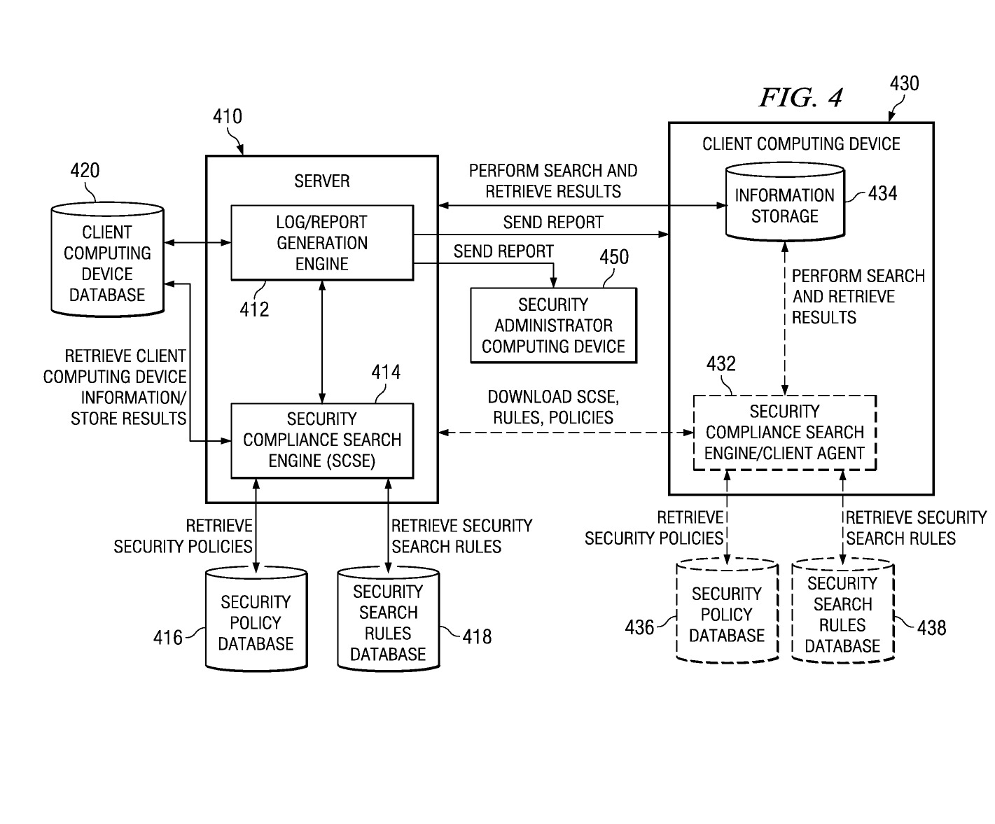

FIG. 4 is an exemplary diagram illustrating the primary operational elements of an illustrative embodiment. As shown in FIG. 4, a server 410 includes a security compliance search engine (SCSE) 414 and a log/report generation engine 412. The SCSE 414 has interfaces to security policy database 416, security search rules database 418, client computing device database 420, and log/report generation engine 412, as well as an interface for communicating, via the server 410, over one or more networks with the client computing device 430. The log/report generation engine 412 has interfaces to client computing device database 420 and SCSE 414, as well as an interface for communication, via the server 410, over one or more networks with the client computing device 430 and security administrator computing device 450.

The SCSE 414 obtains, from the security search rules database 418 security search rules for searching the client computing device 430 for items of information containing confidential content. The SCSE 414 obtains, from security policy database 416, security policies for application to results of a security search of the client computing device 430. These databases 416 and 418 may be regularly updated so as to maintain current the items of interest for security searches of client computing devices.

The SCSE 414 obtains client computing device information from client computing device database 420. This client computing device information may include, for example, network identifiers of the client computing devices, addresses, etc. for identifying the client computing devices that may be the subject of a security search in accordance with the illustrative embodiments. The client computing device database 420 may serve as storage for results of a security search and/or application of security policies to results of a security search.

The SCSE 414 communicates with the client computing device 430, using known network communication protocols, to perform a search of an information storage 434 of the client computing device 430. The information storage 434 may store many different types of items of information including electronic mail messages, instant messages, electronic files, electronic documents, electronic images, or other compilations of data. The information storage 434 may be an actual physical storage device, a plurality of physical storage devices, a portion of a physical storage device, a memory, or the like.

The SCSE 414 applies the security search rules obtained from the security search rules database 418 to the items of information maintained in the information storage 434 to thereby identify items of information in the information storage 434 that contain confidential information. Characteristic information regarding those items of information in the information storage 434 meeting one or more criteria set forth in one or more security search rules is retrieved from the client computing device 430 by the SCSE 414. The characteristic information may be stored in the client computing device database 420 for use with the security policies in determining whether the client computing device 430 is in compliance with current security policy.

The SCSE 414 may apply the security policies obtained from the security policy database 416 to the characteristic information retrieved from the client computing device 430 and generate results indicative of whether one or more of the security policies are violated by the manner in which the client computing device 430 is maintaining one or more items of information in the information storage 434. Information regarding any detected violations may be stored in correlation with entries in the client computing device database for the client computing device 430. These violations may also be notified to the SCSE 414 which may in turn notify the log/report generation engine 412.

The SCSE 414, for identified violations of security policies, may access security policy database 416 to identify suggested solutions for bringing the client computing device 430 into compliance with the established security policy. For example, an identifier of the security policy or policies violated by an item of information may be used to lookup a suggested solution in a data structure of the security policy database 416. This suggested solution information may be provided to the log/report generation engine 412 for use in generating logs and/or reports of the identified violations.

The log/report generation engine 412 may access the client computing device database 420 and/or receive notifications from the SCSE 414 in order to identify violations of security policy. In addition, the log/report generation engine 412 may obtain suggested solutions for identified violations from the SCSE 414 and/or the client computing device database 420. The log/report generation engine 412 generates logs and/or reports which may then be communicated to the client computing device 430 for display to a user of the client computing device 430. The logs and/or reports may also be provided to a security administrator computing device 450 so that a security administrator may be informed of violations occurring in system of client computing devices, including client computing device 430.

As mentioned previously, in some illustrative embodiments, the SCSE 414, a client agent of the SCSE 414, the security policies and security search rules may be downloaded to the client computing device 430, e.g., as SCSE/client agent 432. In such embodiments, the SCSE 414, or portions of the SCSE 414 may executed on the client computing device 414. In FIG. 4, these alternative illustrative embodiments are depicted by elements 432, 436 and 438 which are shown in ghost image to designate them as being part of alternative illustrative embodiments.

FIG. 5 is a diagram illustrating exemplary components of a security compliance search engine in accordance with an illustrative embodiment. As shown in FIG. 5, the security compliance search engine (SCSE) 510 includes a security search rules application module 520, a characteristic information collection module 530, a security policy application module 540, and a results generation module 550. The security search rules application module 520 is responsible for applying security search rules obtained from the security search rules database 418 to items of information in a client computing device. The characteristic information collection module 530 is responsible for collection information characteristic of the manner by which an item of information is maintained in a client computing device for items of information identified by the security search rules application module 520.

The security policy application module is responsible for applying security policies obtained from the security policy database 416 to the characteristic information collected by the characteristic information collection module 530 for items of information identified by the security search rules application module 520. The results generation module 550 is responsible for generating results of the application of the security policies to the characteristic information by the security policy application module 540. The results may be provided to the client computing device database 420 and/or to the log/report generation engine 412.

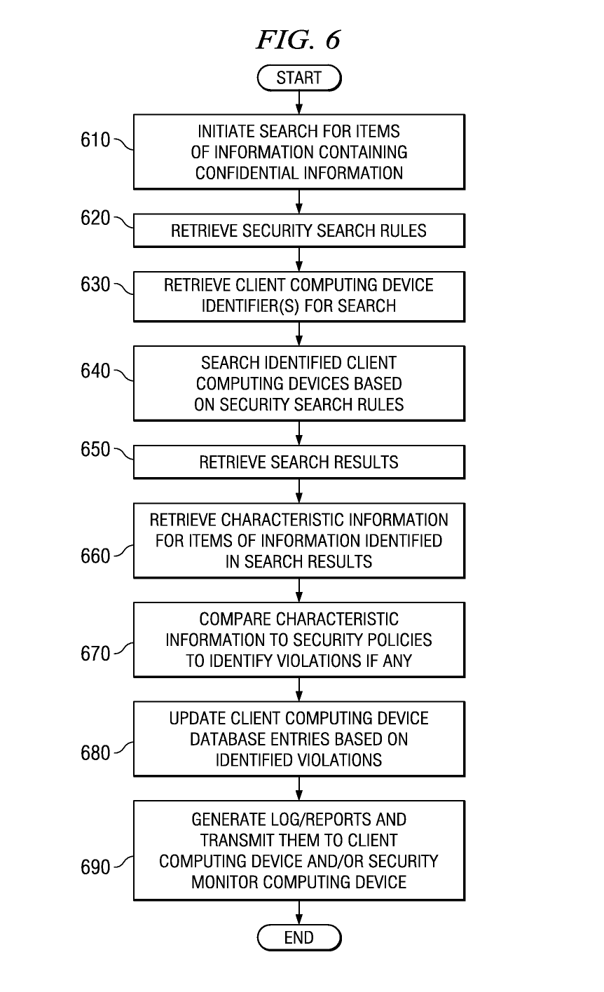

FIG. 6 is a flowchart outlining an exemplary operation for determining compliance of items of information on a client computing device in accordance with an illustrative embodiment. It will be understood, with regard to FIG. 6 and the other flowchart illustrations described hereafter, that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

As shown in FIG. 6, the operation starts by initiating a search for items of information containing confidential information (step 610). Security search rules are retrieved (step 620) and client computing device identifiers for the search are retrieved (step 630). Searches of the identified client computing devices are then performed based on the retrieved security search rules (step 640). Search results are retrieved from the client computing devices (step 650) and characteristic information is retrieved for items of information identified as containing confidential content (step 660).

The characteristic information is compared to security policies to identify violations of the security policies, if any (step 670). The client computing device database entries may then be updated based on identified violations (step 680). Logs/reports of the violations may be generated and transmitted to the client computing device and/or a security monitoring computing device (step 690) and the operation terminates.

Thus, the present invention provides a mechanism for searching a client computing device for items of information that contain confidential content. Based on the results of the search, security policies may be applied to determine if the items of information that contain confidential content are being maintained on the client computing devices in accordance with established security policies. Any violations identified may be reported to a security monitor and/or to the user of the client computing device along with suggested solutions for bringing the client computing device into compliance with the established security policies. In this way, breaches of security policy may be quickly and easily identified in a network of client computing devices and solutions offered for ensuring the confidentiality of items of information containing confidential content.

To report the results of such searching the illustrative embodiments provide a graphical user interface generation engine which generates a graphical user interface that may be provided to a system administrator, end client user, or other interested party. The graphical user interface provides a listing of documents detected, using the mechanisms previously described, as having confidential content and which do not meet security policy requirements. The graphical user interface may further provide, for each such document found to be in violation of security policy requirements, a description of the violation that was detected as well as a description of one or more associated solutions that may be applied to the document to bring it into compliance with the security policy requirements.

Via the graphical user interface, a user may select a document from the listing and one of the one or more listed solutions, i.e. suggested corrective actions, to thereby have the associated solution automatically applied to the selected document. In automatically applying the selected solution to the selected document, the graphical user interface may generate one or more sub-menus, or other graphical user interface elements, for selecting attributes for the selected solution. Such attributes may include, for example, a particular organizational level for which the document is to be accessible. A pre-established security setting, such as an encryption key or the like, that is associated with the selected security attribute may then be retrieved and utilized with the selected security solution to apply the security solution to the selected document.

In yet a further illustrative embodiment, a mechanism is provided for automatically scanning electronic mail messages and their associated attachments to determine if they are in compliance with established security policies. If either the electronic mail message itself or the attachment(s) to the electronic mail message are not in compliance with established security policies, a report may be generated and provided to a user such as via a graphical user interface as previously described.

In one illustrative embodiment, solutions for bringing the electronic mail message into compliance with the security policies may be automatically applied to the electronic mail message and/or its attachments. For example, if the electronic mail message and/or its attachments contain confidential content and are not in compliance with established security policies, the distribution list for the electronic mail message may be automatically modified such that the confidential content is not distributed to individuals that may pose a security risk. Moreover, encryption mechanisms and/or other security solutions may be automatically identified for application to the electronic mail message and/or its attachments and automatically applied. For example, from the electronic mail message's distribution list, it may be determined what level of access within an organization is to be associated with the electronic mail message and its associated attachments and thus, a corresponding security attribute may be selected and used with an automatically selected security mechanism for application to the electronic mail message and its attachments.

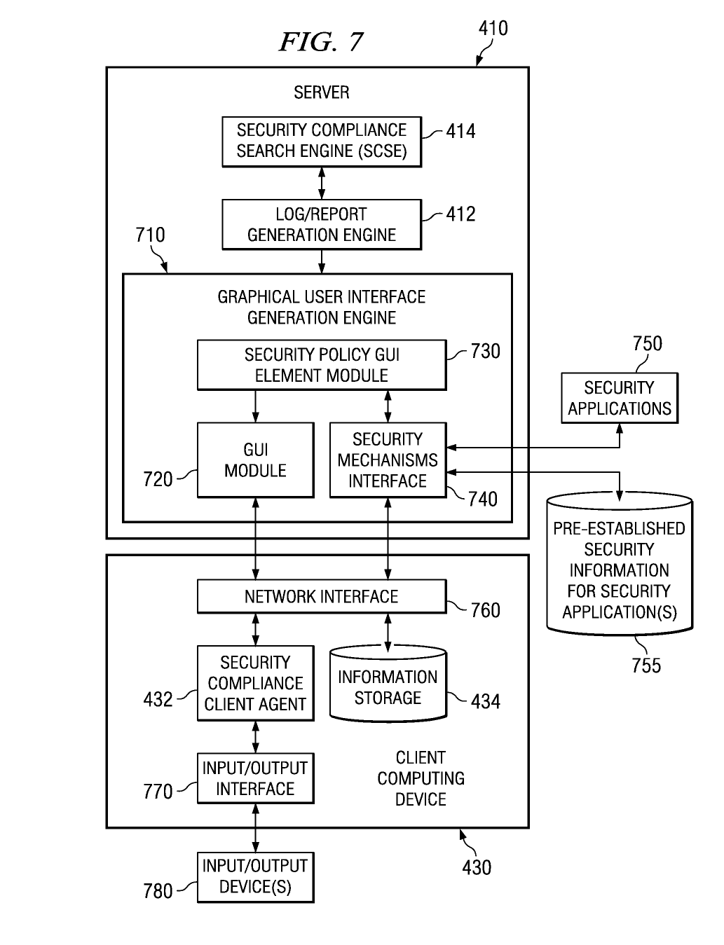

FIG. 7 is an exemplary block diagram illustrating a graphical user interface generation engine in accordance with an illustrative embodiment. The particular embodiment shown in FIG. 7 assumes that the graphical user interface generation engine 710 is provided in a server computing device 410 and provides the graphical user interface and access to security mechanisms via one or more networks to a client computing device 430, which may be associated with an end user, system administrator, or the like. It should be appreciated, however, in a similar manner as described previously with regard to FIG. 4 above, that various elements of the graphical user interface generation engine 710 may be provided as part of the client computing device 430 without departing from the spirit and scope of the present invention.

As shown in FIG. 7, a server computing device 410 is provided with a security compliance search engine (SCSE) 414, a log/report generation engine 412, and a graphical user interface generation engine 710. The SCSE 414 and log/report generation engine 412 may be similar to the corresponding elements described above with regard to FIG. 4 and may operate in substantially the same manner as previous described above. The SCSE 414 is responsible for searching a client computing device or devices for documents that may not be maintained in accordance with security policy requirements. The log/report generation engine 412 is responsible for generating a log or report of any violations of security policy requirements by any documents on client computing devices based on the results of the searching performed by the SCSE 414. Such searching and log/report generation is performed in substantially the same manner as described above.

The log/report generation engine 412, in the depicted illustrative embodiment, provides the log or report to the graphical user interface generation engine 710. The graphical user interface (GUI) generation engine 710 includes a graphical user interface module 720, a security policy GUI elements module 730, and a security mechanisms interface 740. The GUI module 720 is responsible for the actual generation of a GUI to be provided to the client computing device 430 based on the results of the search and reporting performed by the SCSE 414 and log/report generation engine 412. The GUI that is generated by the GUI module 720 may include information including the name, optionally including a full path, of the document(s) that have been detected as containing confidential information that is being maintained contrary to the established security policy requirements and an indication of the violation that was detected by the search. This information may be obtained form the log/report generated by the log/report generation engine 412.

In addition, the GUI may include suggested corrective actions that may be performed to bring the identified document into compliance with the established security policy. As described previously, these suggestions may be identified by the SCSE 414 and provided in the log/report generated by the log/report generation engine 412. The security policy GUI elements module 730 may, based on the results returned in the log/report generated by the log/report generation engine 412, generate textual descriptions of and user selectable GUI elements for the various suggested corrective actions such that these suggested corrective actions may be displayed in a selectable manner to a user of the client computing device 430. For example, if the log/report generated by the log/report generation engine 412 indicates that a document contains confidential information and that the document is an image file, the SCSE 414 may determine that the image file should be compressed and password protected. A corresponding GUI element may be generated by the security policy GUI element module 730 to perform such compression and password protection in response to a user's selection of the generated GUI element.

The security policy GUI elements module 730 may generate GUI elements based on information obtained from the security application(s) 750 and pre-established security information for security application(s) 755 storage via the security mechanisms interface 740. The security mechanisms interface 740 further provides an interface through which user selections of security policy GUI elements may be used to access the security application(s) 750 using pre-established security information for security applications 755, as described hereafter.

The security application(s) 750 may comprise any number of security applications for applying security measures to documents so that these documents are maintained on client computing devices in accordance with security policy requirements. Such security applications may include encryption algorithm applications, compression algorithm applications, password protection applications, and the like.

Some of these security applications may require the entry of security attribute information in order for the applications to operate properly on the identified documents. Such security attribute information may comprise, for example, a type of encryption to be applied, encryption keys to be utilized, seed values, passwords, and other types of inputs that govern the manner by which the applications operate on the identified documents. Standardized versions of these inputs, which may be used by a plurality of users in an organization, may be provided in the pre-established security information for security application(s) data storage 755, for example.

These standardized versions of the security attribute information inputs, in one illustrative embodiment, are utilized to provide access to the documents by individuals in the organization that have a particular level of access within the organization. Thus, for example, a user may be provided with the option to select a level of access, e.g., group, department, etc., for which the document is to be made accessible and this level of access may be translated into a particular encryption key or keys, password or passwords, encryption algorithm, or the like that is a standard for that level of accessibility within the organization. Such translation may be performed, for example, by the security mechanisms interface 740 based on information stored in the pre-established security information for security applications data storage 755.

In operation, a user of the client computing device 430 may, via the input/output devices 780, the input/output interface 770 and the security compliance client agent 432, request a report of security violations be output for use by the user. The security compliance client agent 432 may send a request for security violations report to the GUI generation engine 710 via the network interface 760. In response, the GUI module 720 interfaces with the security policy GUI elements module 730 and retrieves the latest log/report generated by the log/report generation engine 412 to thereby generate a GUI for transmission to the client computing device 430.

The security policy GUI elements module 730 interfaces with the security mechanism interface 740 to access information regarding the security applications 750 and pre-established security information for security applications in data storage 755 to aid in generating the GUI elements to be used with security mechanism suggestions in the GUI generated by the GUI module 720. Such generation may include, for example, obtaining textual descriptions the security mechanisms, generating drop down menus or other GUI elements for selection of security mechanism attributes to be used with selected security mechanisms, and the like.

The GUI module 720 generates the GUI and transmits the GUI to the security compliance client agent 432 via one or more networks (not shown) and the network interface 760. The security compliance client agent 432 outputs the GUI via the input/output interface 770 and input/output devices 780 for use by the user. As mentioned above, the GUI may include a listing of documents containing classified information that are not being maintained in compliance with established security policies. This listing may identify the documents and their corresponding violation of security policy. The listing may further include corresponding security policy GUI elements generated by the security policy GUI elements module 730.

Via the GUI, a user may select a listed document and an associated security policy GUI element to thereby apply the corresponding security mechanism to the selected document in the list. As part of this selection, the user may further be asked to select a particular security mechanism attribute, e.g., level of access, password, encryption key, etc., to be used with the selected security mechanism. In one illustrative embodiment, the user may select a particular level of access to be associated with the selected document. This particular level of access may then be automatically translated into a particular password, encryption key, or the like, that is associated with the selected level of access and used with the security mechanism to protect the confidential information in the selected document.

The selection of the document, security mechanism, and security mechanism attribute are used to generate a request that is sent to the security mechanisms interface 740. The security mechanisms interface 740 performs the necessary translation, if any, of the selected security mechanism attribute using information maintained in the pre-established security information for security applications data storage 755. The security mechanisms interface 740 further initiates the security application 750 associated with the selected security mechanism on the identified document in the information storage 434 of the client computing device 430.

After successful completion of the application of the security mechanism to the selected document, the security mechanisms interface 740 may communicate the successful completion to the security compliance client agent 432 which may update the GUI that is output via the input/output devices 780 such that the GUI represents the selected document as now being in compliance with security policy requirements. Alternatively, if the application of the security mechanism to the selected document results in an error, an error message may be reported to the user via an updated GUI in a similar manner.

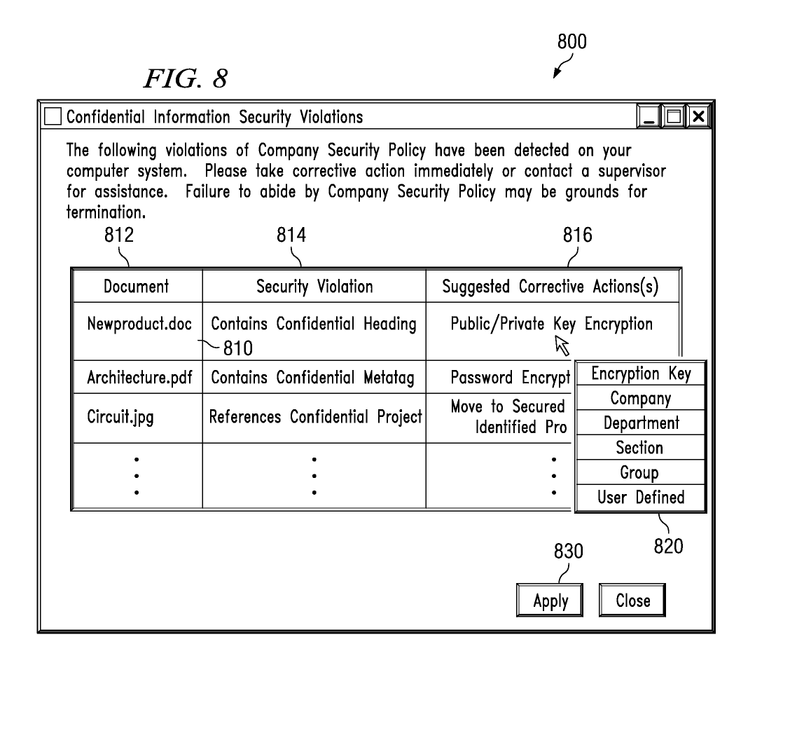

FIG. 8 is an exemplary diagram of a GUI that may be output in accordance with one illustrative embodiment. As shown in FIG. 8, the GUI 800 includes a listing 810 of documents that have been found, through a search of a client computing device such as previously described, to contain confidential information and to not be maintained in accordance with established security policy. While FIG. 8 illustrates a listing 810 for a single client computing device, it should be appreciated that multiple listings may be made available for each of a plurality of client computing devices without departing from the spirit and scope of the present invention. Moreover, the particular arrangement and content of the listing as shown in FIG. 8 is not intended to be limiting with regard to the particular types of information that may be provided in such a listing. To the contrary, other information pertaining to documents identified as containing confidential information and being in violation of established security policy may be displayed in the GUI 800 in addition to, or in replacement of, the information depicted in FIG. 8 without departing from the spirit and scope of the present invention.

The listing 810 includes a first column 812 in which identifiers of documents containing confidential information are provided. In a second column 814, security policy violations are listed in association with the documents identified in the first column 812. In a third column 816, suggested corrective actions for bringing the document into compliance with security policies are provided. The user may use an input device, such as a computer mouse, to select entries in the listing 810. Moreover, the user may select one of the suggested corrective actions from the column 816 in association with a selected document and thereby apply the suggested corrective action to the selected document. As part of the selection, a pop-up menu, drop-down menu, or other GUI element may be displayed to the user such that the user may select a security mechanism attribute to be used in applying the selected suggested corrective action to the selected document. As shown in FIG. 8, this GUI element 820 may have a listing of possible security mechanism attributes from which the user may select.

In the depicted example, the GUI element 820 includes a listing of access levels which the user may select from. The selected access level is to be translated into an appropriate password, encryption key, or the like, that is utilized by the selected security mechanism to secure the contents of the selected document. For example, if the user selects the security mechanism attribute “Section” then an associated encryption key for the section of the organization in which the author of the document is located may be used with the security mechanism that is applied to the selected document. The translation of the selected access level to a particular security mechanism attribute may be handled by the security mechanisms interface 740 in FIG. 7, for example.

After having selected the document, the security mechanism, and the security mechanism attribute, if any, the user may select the “apply” GUI virtual button 830 to thereby submit a request to apply the selected security mechanism, using the selected security mechanism attribute, to the selected document. The user's selections are converted into an electronic request that is sent to the server computing device 710 in FIG. 7, for example, which processes the request to thereby apply the selected security mechanism to the selected document using the selected security mechanism attribute.

Thus, in addition to searching documents on client devices and providing logs/reports of security policy violations, the illustrative embodiments provide a mechanism through which a graphical user interface may be provided to a user that identifies the documents and their corresponding security policy violations. Moreover, the graphical user interface provides a mechanism through which the user may apply corrective actions to the documents that are in violation of security policies.

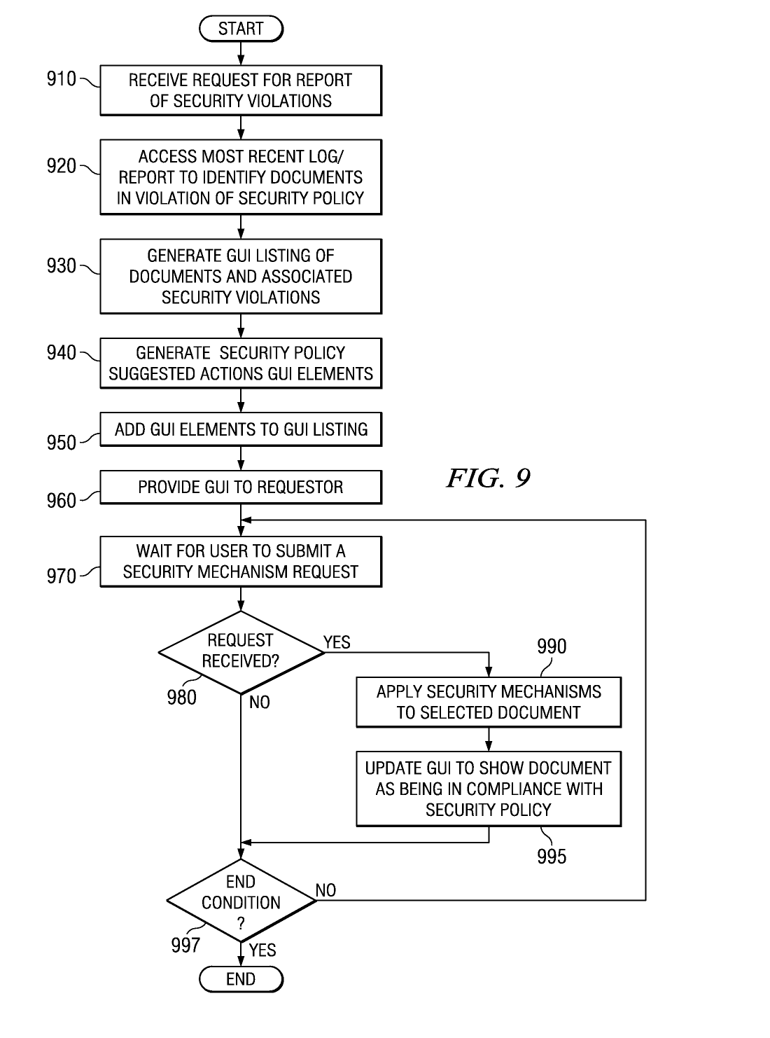

FIG. 9 is a flowchart outlining an exemplary operation for providing a graphical user interface in accordance with one illustrative embodiment. As shown in FIG. 9, the operation starts with the graphical user interface generation engine receiving a request for a report of security policy violations (step 910). The GUI generation engine accesses the most recent log/report generated by the log/report generation engine to identify documents that are in violation of established security policy along with information regarding the particular violations (step 920). A GUI listing of documents and their associated security violations is generated by the GUI generation engine (step 930). Security policy suggested actions GUI elements are then generated by the security policy GUI elements module based on the information regarding the particular violations of the documents in the log/report (step 940). The GUI generation engine adds the GUI elements to the GUI listing (step 950) and provides the resulting GUI to the requester (step 960).

The operation then waits for the user to submit a request for application of a security mechanism to a document included in the GUI listing (step 970). A determination is made as to whether such a request is received (step 980). If so, the GUI generation engine applies the appropriate security application(s) corresponding to the selected security mechanism, using the selected security mechanism attribute(s), to the document identified in the request (step 990). The security compliance client agent may then update the GUI to reflect that the document has been brought into compliance with established security policy (step 995).

Thereafter, or if a request has not been received from the user, a determination may be made as to whether an end condition has occurred (step 997). Such an end condition may be, for example, the user closing the GUI or otherwise discontinuing the operation outlined in FIG. 9. If an end condition has occurred, the operation terminates. Otherwise, if an end condition has not occurred, the operation returns to step 970 and waits for another user input via the generated GUI.

The GUI mechanism described above provides a convenient and easy to use mechanism for obtaining information about documents that violate security policies and rectifying such violations. The GUI mechanism described above operates in response to a user requesting a report of the document violations that have been detected by the security compliance search engine and reported or logged by the log/report generation engine. A similar GUI mechanism may operate automatically in response to detected violations, i.e. without requiring a user request to generate the GUI.

As a further illustrative embodiment, the security compliance search engine (SCSE) 414, log/report generation engine 412, and GUI generation engine 710 may operate automatically in response to the composing of a document. For example, the operational elements 412, 414 and 710 may operate on electronic mail messages and their attachments that are composed by a user of a client computing device 430.

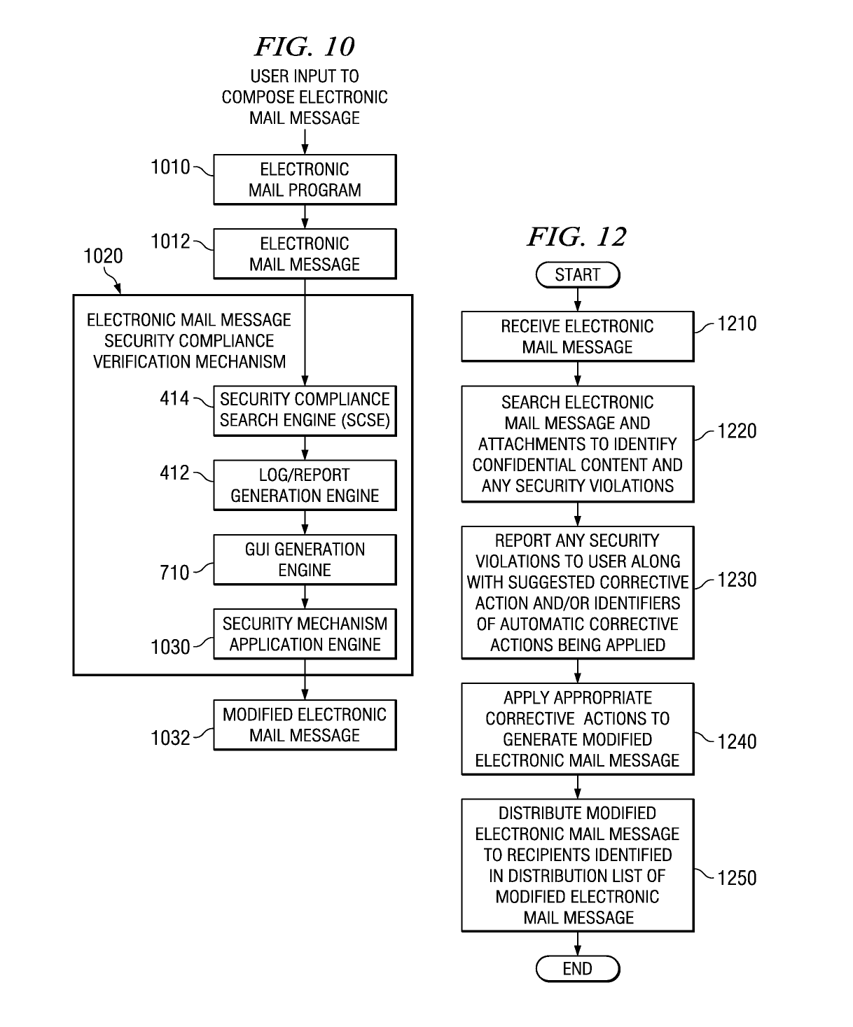

FIG. 10 is an exemplary diagram illustrating an operation of an electronic mail message security compliance verification mechanism in accordance with an illustrative embodiment. The electronic mail message security compliance verification mechanism 1020 utilizes the SCSE 414, log/report generation engine 412, and GUI generation engine 710 to perform verification, reporting, and correction of security policy violations on an individual basis for electronic mail messages composed by a user.

A user may compose an electronic mail message 1012 in a normal fashion using an electronic mail program 1010, such as Microsoft Outlook™, or the like, by designating email addresses of individuals to which the electronic mail message 1012 is to be sent, a subject of the electronic mail message 1012, providing content, inserting any attachment files to the electronic mail message 1012, and the like, as is generally known in the art. Prior to distributing the electronic mail message 1012, however, the electronic mail message 1012 is subjected to the electronic mail message security compliance verification mechanism 1020 of the illustrative embodiments. These mechanisms may be provided on the client computing device itself and thus, may operate local to the electronic mail program 1010, or may be part of a server computing device that acts as the electronic mail server for the client computing device, for example. In the latter case, the electronic mail message 1012 must be sent to the electronic mail server before it is searched and any violations of security policy are reported. Thus, it is important in the latter case that the communication link between the client computing device and the server computing device be secure. To secure such a link, various security protocols may be utilized, such as https, or the like, as are generally known in the art.

Similar to other documents, the security compliance search engine (SCSE) 414 searches the electronic mail message 1012, including its contents, metadata, subject line, attachments, and the like, to identify if any of these portions of the electronic mail message 1012 contain confidential content. If confidential content is discovered, the SCSE 414 determines if the manner by which this confidential content is maintained in the electronic mail message 1012 is in compliance with established security policies. If not, the violation is identified and information about the violation is provided to the log/report generation engine 412. As discussed above, the identification of such violations may be made based on security search rules that have been established, for example.

For example, the SCSE 414 may search the electronic mail message 1012 and its attachments to determine if confidential content is referenced in the text of the electronic mail message 1012 and whether confidential content is present in the attachments. If references to confidential content are made in the text of the electronic mail message 1012, the SCSE 414 may determine whether the text, the subject, the title, etc., of the electronic mail message 1012 has a suitable “confidential” statement or indicator to clearly identify the text as being confidential. If not, a security violation may be identified and reported.

With regard to the attachments, if the attachments are determined to contain confidential content, the SCSE 414 may determine whether the attachments have appropriate encryption, password protection, or the like, to ensure their secrecy. If the attachments are not appropriately encrypted, password protected, or the like, then a security violation may be identified and reported.

The illustrative embodiments may use the GUI mechanism previously described to display a report of the violations for the electronic mail message 1012. Thus, similar to the GUI shown in FIG. 8, the GUI generation engine 710 may generate a GUI that identifies the security violations and suggested corrective action for the security violations. Since this search and reporting is performed on an individual basis in response to a user attempting to transmit the electronic mail message 1012, it is not necessary to identify the electronic mail message 1012 in the GUI.

Similar to the embodiments described above, the user may select an appropriate suggested corrective action, an associated security mechanism attribute, if any, and have a corresponding security mechanism applied to the electronic mail message and/or attachments. Thus, the user may be informed of security violations of a composed electronic mail message 1012 and its attachments and may be given the option to apply corrective actions to bring the electronic mail message 1012 into compliance with established security policies.

In a further illustrative embodiment, corrective actions may be automatically applied to the electronic mail message 1012 and/or its attachments prior to the electronic mail message 1012 being transmitted to the recipients. In response to the detection and reporting of security policy violations, appropriate corrective actions are identified and automatically applied by a security mechanism application engine 1030, which may or may not be part of the electronic mail message security compliance verification mechanism 1020. These corrective actions modify the electronic mail message 1012 so that the resulting modified electronic mail message 1032 is in compliance with established security policies for electronic mail messages and their attachments.

For example, if the text of the electronic mail message 1012 contains references to confidential content, or contain confidential content itself, and the electronic mail message 1012 does not have an identifier indicating the electronic mail message 1012 as containing confidential content, then a security violation may be identified and reported. In response to the identification of this security violation, a security mechanism may be applied to the electronic mail message 1012 to automatically insert an identifier in the subject line of the electronic mail message 1012 that the electronic mail message 1012 contains confidential content. In addition, a suitable confidential statement may be added to the textual content in the body of the electronic mail message 1012 to indicate that the content of the electronic mail message 1012 is confidential.

As a further example, if the attachment of the electronic mail message 1012 is determined to contain confidential content, then a suitable encryption algorithm and encryption key may be automatically determined and applied to the attachment. The selection of the encryption algorithm and key may be performed based on security policy rules, for example. In one illustrative embodiment, the particular encryption key utilized may be selected based on the access level of the author of the electronic mail message 1012 and/or the access levels of the intended recipients of the electronic mail message 1012, for example. Thus, for example, if the author of the electronic mail message 1012 is sending the electronic mail message 1012 to recipients in his/her own department within the organization, then the encryption key used to encrypt the attachments would be the pre-established encryption key for the author's department, as assigned by a system administrator.

As yet another example of modifications that may be automatically made to an electronic mail message 1012 based upon security violations, the illustrative embodiments may modify the distribution of the electronic mail message 1012 so as to minimize exposure of confidential content to unsecure individuals, i.e. individuals inside or outside the organization that do not have sufficient access level to be allowed access to the confidential content. Thus, for example, if confidential content is determined to be present within the text of the electronic mail message 1012 or in the attachments, the distribution list may be checked to determine if any of the intended recipients are unsecure recipients. Such a check may involve comparing the electronic mail addresses of each of the recipients to a list of secure recipients that may be maintained as part of the security policy database, for example. If any of the recipients are determined to be unsecure, the SCSE 414 may identify a security violation and report the security violation to the user via the log/report generation engine 412, for example. An appropriate GUI may be displayed to the user for identifying the intended recipient that is determined to be an unsecure recipient. The user may then be given the option to correct the electronic mail message's distribution list so as to avoid sending the electronic mail message 1012 to unsecure recipients.

Alternatively, the identified unsecure recipients may be automatically removed from the distribution list for the electronic mail message 1012 and a suitable GUI indicating the removal of these recipients may be displayed to the user. The distribution list of the electronic mail message 1012 may be modified automatically by simply removing the identified unsecure recipient's electronic mail addresses from the metadata associated with the electronic mail message 1012 such that the electronic mail message is not replicated and sent to these electronic mail addresses. In this way, the user is automatically prevented from sending confidential content to unsecure recipients.

In each of the cases described above, distribution of the electronic mail message 1012 is prevented until the electronic mail message 1012 is brought into compliance with established security policy. Thus, automatic application of security mechanisms, user implemented application of security mechanisms, or a combination of both may be required before the electronic mail message 1012 is permitted to be sent to the identified recipients. Only when the electronic mail message 1012 is in compliance with security policies will the electronic mail message 1012 be permitted to be sent to the intended recipients.

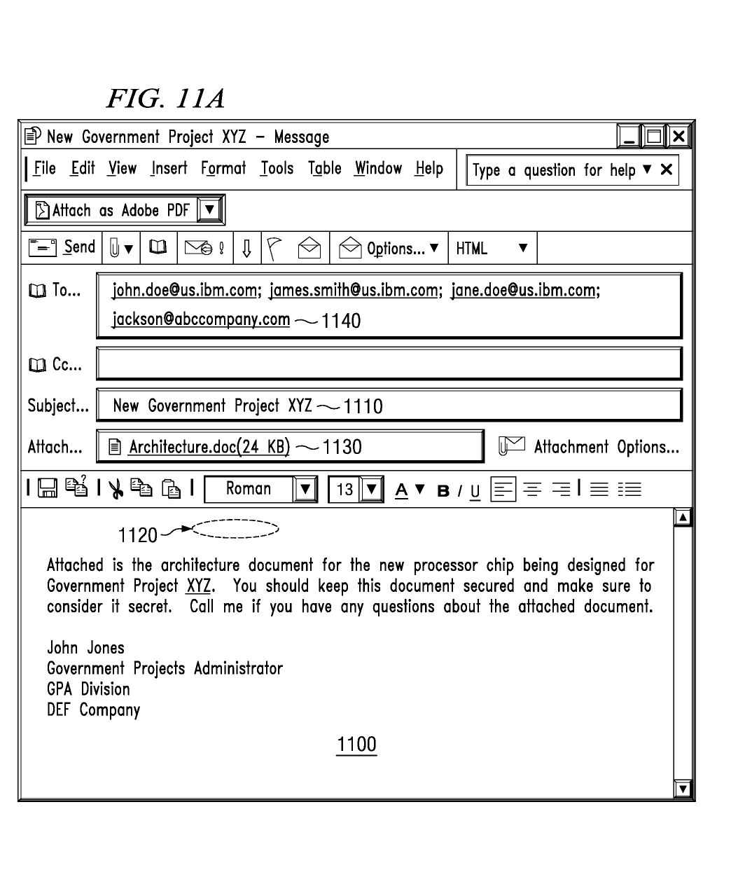

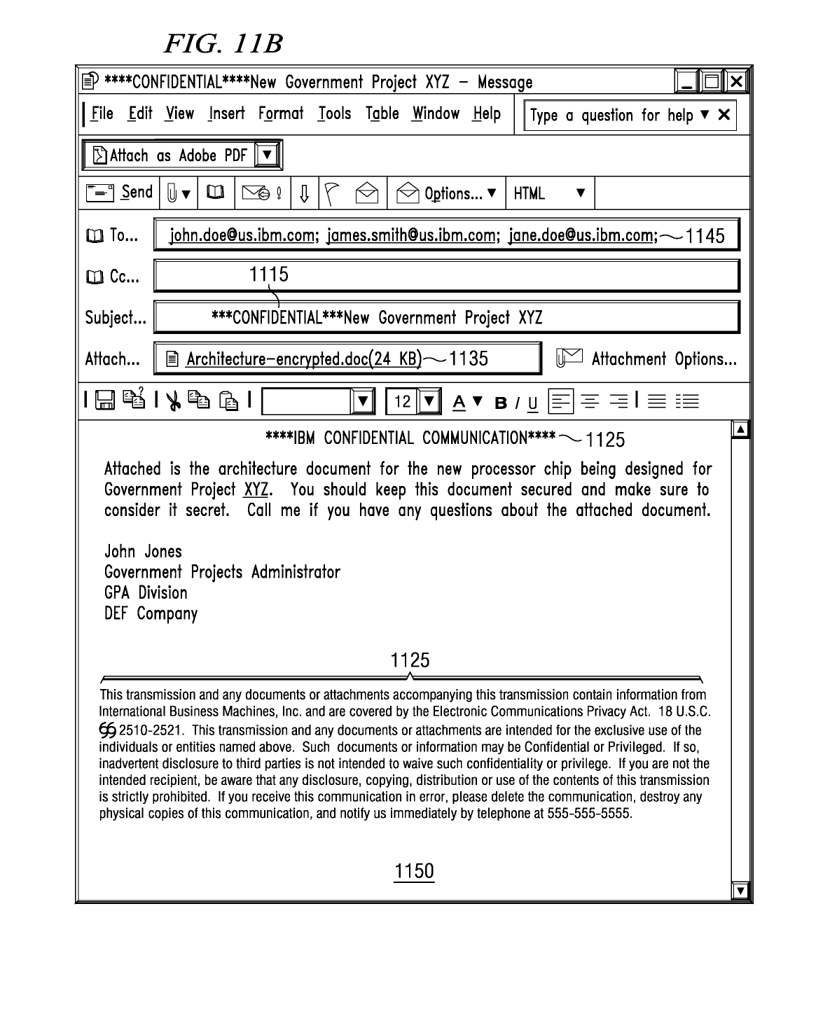

FIG. 11A is an exemplary diagram illustrating an initial electronic mail message as composed by a user. The electronic mail message shown in FIG. 11A may correspond, for example, to the electronic mail message 1012 in FIG. 10. FIG. 11B is an exemplary diagram illustrating a modified electronic mail message that is generated based on the electronic mail message shown in FIG. 11A and the application of security mechanisms in accordance with an illustrative embodiment. The electronic mail message shown in FIG. 11B may correspond, for example, to the modified electronic mail message 1032 in FIG. 10.

As shown in FIG. 11A, through searching of the electronic mail message 1100 using the SCSE 414, it is determined that the electronic mail message 1100 references confidential information, i.e. the new government project, and has an attachment that contains confidential information. Furthermore, it is determined, using the SCSE 414, that a number of security violations are present. A first security violation 1110 is that the text of the electronic mail message 1100 references confidential information but there is no indication of the confidentiality in the subject line of the electronic mail message. A second security violation 1120 is that the text of the electronic mail message 1100 does not include a confidentiality statement. A third security violation 1130 is that the attachment contains confidential information and is not properly encrypted. A fourth security violation 1140 is that the distribution list for the electronic mail message includes an unsecure recipient.

Thus, through the mechanisms of the illustrative embodiments, such as the SCSE 414, the log/report generation engine 412, the GUI generation engine 710, and the like, these security violations may be identified and reported to a user. Moreover, appropriate security mechanisms may be applied, such as via the security mechanism interface 740, to the electronic mail message 1100 to correct these various security violations 1110-1140. Such application of security mechanisms may be performed automatically, by a user through selection of the security mechanisms via a GUI such as illustrated in FIG. 8, for example, or a combination of automatic and user instigated application of security mechanisms. The resulting modified electronic mail message is then in compliance with security policies and may be distributed to the intended recipients.

FIG. 11B illustrates the modified electronic mail message 1150 after application of the security mechanisms, either automatically, in response to user selections, or both, to correct the identified security violations. As shown in FIG. 11B, through operation of the illustrative embodiments, the first security violation 1110 is corrected by including an indication 1115 of the confidentiality in the subject line of the modified electronic mail message 1150. The second security violation 1120 is corrected by including a confidentiality statement 1125 in the body text of the modified electronic mail message 1150. The third security violation 1130 is corrected by properly encrypting the attachment and re-attaching the encrypted attachment 1135 to the modified electronic mail message 1150. The fourth security violation 1140 is corrected by modifying the distribution list 1145 to remove the unsecure recipient. Thus, the modified electronic mail message 1150 is now in compliance with established security policy and may be distributed to the identified recipients in the distribution list 1145.

FIG. 12 is a flowchart outlining an exemplary operation for ensuring compliance of electronic mail messages and their attachments with security policies in accordance with one illustrative embodiment. As shown in FIG. 12, the operation starts by receiving, in an electronic mail message security compliance verification mechanism, an electronic mail message from an electronic mail program (step 1210). The electronic mail message security compliance verification mechanism searches the electronic mail message and its attachment to identify confidential content and any security violations with regard to identified confidential content (step 1220). The electronic mail message security compliance verification mechanism may then report any security violations to a user along with suggested corrective action and/or identifiers of automatic corrective actions that are being applied to the electronic mail message (step 1230).

Appropriate corrective actions are applied, via the electronic mail message security compliance verification mechanism, to the electronic mail message and/or its attachments so as to generate a modified electronic mail message that is in compliance with established security policies (step 1240). As described above, these corrective actions may be automatically applied, user initiated, or any combination of automatic and user initiated applications of security mechanisms that perform these corrective actions.

The electronic mail message security compliance verification mechanism may then distribute the modified electronic mail message to the recipients identified in the distribution list of the modified electronic mail message (step 1250). The operation then terminates.

Thus, in addition to providing a search and reporting mechanism for identifying security policy violations with regard to the maintaining of confidential information, the illustrative embodiments provide mechanisms for ensuring the adherence to security policies with regard to confidential information in the distribution of electronic mail messages. The mechanisms of the illustrative embodiments allow for the automatic, user initiated, or a combination of automatic and user initiated, application of security mechanisms to identified security violations in an electronic mail message and/or its attachments prior to the electronic mail message being distributed to the identified recipients. In addition, the illustrative embodiments provide mechanisms for automatically modifying the recipients of the electronic mail message so as to ensure that the electronic mail message is not provided to unsecure recipients.

It should be appreciated that while the illustrative embodiments have been described in terms of graphical user interface (GUI) generation and the reporting of security violations and suggested corrective options via a GUI, the present invention is not limited to reporting via a GUI. To the contrary, similar reporting and providing of suggested corrective options may be provided via a command line as well, for example. A command line tool may read report logs and provide corrective actions from the command line without the need for a GUI, in much the same manner as described above. The present invention is intended to encompass any mechanisms for reporting such security violations and providing suggested corrective options.

It is important to note that the illustrative embodiments may take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the illustrative embodiments may take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

As described previously, a data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, in a data processing system, of reporting items of information containing confidential information, comprising:
identifying at least one item of information containing the confidential information based on one or more security search rules setting forth one or more security criteria for identifying the items of information that contain the confidential information;
analyzing the at least one item of information to determine if the at least one item of information meets security policy compliance requirements, wherein the security policy compliance requirements identify requirements for maintaining the items of information that contain the confidential information in a confidential state;
identifying one or more security policy violations based on results of the analysis in response to the results indicate that the at least one item of information does not meet the security policy compliance requirements; and
providing an output identifying the at least one item of information, wherein the output includes, for each item of information in the at least one item of information, an identifier of the item of information and the one or more security policy violations associated with the item of information.

2. The method of claim 1, wherein the output further includes an identifier of one or more suggested corrective actions for correcting the one or more security policy violations.

3. The method of claim 1, wherein providing an output comprising providing a graphical user interface, and wherein the graphical user interface includes one or more graphical user interface elements associated with the one or more suggested corrective actions, the one or more graphical user interface elements being selectable by a user to perform the one or more associated corrective actions.

4. The method of claim 3, further comprising:
receiving first user input that selects an item of information from the at least one item of information;
receiving second user input that selects one of the one or more suggested corrective actions associated with the selected item of information; and
automatically applying one or more operations associated with the selected suggested corrective action to the selected item of information in response to the first and second user inputs.

5. The method of claim 4, further comprising:
providing a secondary graphical user interface element, in response to the second user input, identifying one or more security attributes to be utilized by operations associated with the selected suggested corrective action; and
receiving third user input that selects one of the one or more security attributes.

6. The method of claim 5, wherein the one or more security attributes include a particular organizational level for which the selected item of information is to be accessible.

7. The method of claim 5, further comprising:
retrieving a pre-established security setting associated with the selected security attribute; and
providing the pre-established security setting to the one or more operations associated with the selected suggestive corrective action.

8. (canceled)

9. The method of claim 1, further comprising:
automatically identifying one or more corrective actions to correct the one or more security policy violations; and
automatically applying the identified one or more corrective actions to the at least one item of information to bring the at least one item of information into compliance with security policies.

10. The method of claim 9, wherein the at least one item of information is an electronic mail message, and wherein the one or more corrective actions include at least one of automatically modifying a distribution list for the electronic mail message to not include unauthorized individuals that may pose a security risk, automatically encrypting the electronic mail message, or automatically encrypting an attachment to the electronic mail message.

11. A computer program product comprising a computer useable medium having a computer readable program recorded thereon, wherein the computer readable program, when executed on a computing device, causes the computing device to:
identify at least one item of information containing confidential information based on one or more security search rules setting forth one or more security criteria for identifying items of information that contain the confidential information;
analyze the at least one item of information to determine if the at least one item of information meets security policy compliance requirements, wherein the security policy compliance requirements identify requirements for maintaining the items of information that contain the confidential information in a confidential state;
identify one or more security policy violations based on results of the analysis in response to the results indicate that the at least one item of information does not meet the security policy compliance requirements; and
provide an output identifying the at least one item of information, wherein the output includes, for each item of information in the at least one item of information, an identifier of the item of information and the one or more security policy violations associated with the item of information.

12. The computer program product of claim 11, wherein the output further includes an identifier of one or more suggested corrective actions for correcting the one or more security policy violations.

13. The computer program product of claim 11, wherein the computer readable program causes the computing device to provide an output by providing a graphical user interface, and wherein the graphical user interface includes one or more graphical user interface elements associated with the one or more suggested corrective actions, the one or more graphical user interface elements being selectable by a user to perform the one or more associated corrective actions.

14. The computer program product of claim 13, wherein the computer readable program further causes the computing device to:
receive first user input that selects an item of information from the at least one item of information;
receive second user input that selects one of the one or more suggested corrective actions associated with the selected item of information; and
automatically apply one or more operations associated with the selected suggested corrective action to the selected item of information in response to the first and second user inputs.

15. The computer program product of claim 14, wherein the computer readable program further causes the computing device to:
provide a secondary graphical user interface element, in response to the second user input, identifying one or more security attributes to be utilized by operations associated with the selected suggested corrective action; and
receive third user input that selects one of the one or more security attributes.

16. The computer program product of claim 15, wherein the one or more security attributes include a particular organizational level for which the selected item of information is to be accessible.

17. The computer program product of claim 15, wherein the computer readable program further causes the computing device to:
retrieve a pre-established security setting associated with the selected security attribute; and
provide the pre-established security setting to the one or more operations associated with the selected suggestive corrective action.

18. The computer program product of claim 11, wherein the computer readable program further causes the computing device to:
automatically identify one or more corrective actions to correct the one or more security policy violations; and
automatically apply the identified one or more corrective actions to the at least one item of information to bring the at least one item of information into compliance with security policies.

19. The computer program product of claim 19, wherein the at least one item of information is an electronic mail message, and wherein the one or more corrective actions include at least one of automatically modifying a distribution list for the electronic mail message to not include unauthorized individuals that may pose a security risk, automatically encrypting the electronic mail message, or automatically encrypting an attachment to the electronic mail message.

20. A system for reporting items of information containing confidential information, comprising:
a processor; and
a memory coupled to the processor, wherein the memory contains instructions which, when executed by the processor, cause the processor to:
identify at least one item of information containing the confidential information based on one or more security search rules setting forth one or more security criteria for identifying the items of information that contain the confidential information;
analyze the at least one item of information to determine if the at least one item of information meets security policy compliance requirements, wherein the security policy compliance requirements identify requirements for maintaining the items of information that contain the confidential information in a confidential state;
identify one or more security policy violations based on results of the analysis in response to the results indicate that the at least one item of information does not meet the security policy compliance requirements; and
provide an output identifying the at least one item of information, wherein the output includes, for each item of information in the at least one item of information, an identifier of the item of information and the one or more security policy violations associated with the item of information.
